(19) United States
(12) Patent Application Publication
(10) Pub. No.: US 2010/0161890 A1
(43) Pub. Date: Jun. 24, 2010

(54) CACHE MANAGEMENT METHOD AND CACHE DEVICE USING SECTOR SET

(76) Inventors: Hyo-Jun KIM, Yongin-si (KR); Dong-jun Shin, Hwaseong-si (KR)

Correspondence Address: North Star Intellectual Property Law, PC, P.O. Box 34688, Washington, DC, 20043, US

(21) Appl. No.: 12/717,177

(22) Filed: Mar. 4, 2010

Related U.S. Application Data
(63) Continuation of application No. PCT/KR2007/005608, filed on Nov. 8, 2007.

(30) Foreign Application Priority Data
Sep. 5, 2007 (KR) 10-2007-0089972

(51) Int. Cl. G06F 12/00; G06F 12/02; G06F 12/08

(52) U.S. Cl. 711/103; 711/118; 711/E12.008; 711/E12.017

(57) ABSTRACT

A cache management method and a cache device using a sector sets, are provided. The cache management method includes receiving at least one of a write request and a read request for predetermined data, from a host device. The cache determines whether a cache memory is allocated to a sector set including the predetermined sector, and selectively allocates the cache memory to the sector set based on the result of determination. The cache may store the data in the cache memory allocated to the sector set.

### CROSS REFERENCE TO RELATED APPLICATIONS

This application is a continuation of International Application PCT/KR2007/005608, filed on Nov. 8, 2007, which claims the benefit of Korean Patent Application No. 10-2007-0089972, filed Sep. 5, 2007, in the Korean Intellectual Property Office, the entire disclosures of which are both incorporated herein by reference for all purposes.

### BACKGROUND

1. Field

The following description relates to a cache management method and a cache device, and more particularly, to a method and device for caching data in order to reduce the number of writing and erasing operations performed in the storage device.

2. Description of Related Art

Flash memory is a non-volatile memory element that may electrically write or erase data. Compared to a magnetic disk storage device, flash memory consumes less electric power and has a smaller size. Thus, flash memory is being actively researched and developed as an alternative to magnetic disk memory. For example, flash memory, regarded as a solid state disk (SSD), is expected to replace the memory of mobile devices such as digital cameras, mobile phones, personal digital assistants (PDAs), external hard disks, and the like.

Unlike hard disks which enable overwriting, flash memory does not enable overwriting. Accordingly, in order to write new data on a region where previous data is already written, the previous data has to be erased before the new data is written. That is, memory blocks have to be initialized so that a write operation may be enabled. In the flash memory, an erase operation often requires more time than a write operation. Furthermore, the write operation is performed in pages while the erase operation is performed in memory blocks which are sets of pages. Accordingly, undesired pages may also be erased, thus resulting in inefficiency.

Due to the above-described problem, when a storage device is designed based on flash memory, it is desirable to improve the performance of the write and erase operations of the flash memory. A conventional cache management method and a conventional cache device do not consider the above-described particular characteristic of the flash memory, and thus the performance of the write and erase operations lacks efficiency.

FIG. 1 illustrates a conventional cache management method.

Referring to FIG. 1, if a host device 110 requests to write or read data in sectors, a cache device 120 temporally stores sectors that are requested to write or read data. Sector data requested as write data is not directly written into a storage device 130, and is temporally stored in cache memory. Sector data requested as read data is read from the storage device 130 and is temporally stored in the cache memory so that the host device 110 does not read the data of the sectors directly from the storage device 130, but instead reads the data of the sectors from the cache device 120.

If the conventional method uses a least recently used (LRU) algorithm, the hit ratio of access of the host device 110 in the cache device 120 is increased by sequentially flushing the LRU sectors into the storage device 130 and only storing the most recently used (MRU) sectors from among the sectors temporally stored in the cache memory.

As described above, in flash memory, an erase operation is performed in memory blocks and a plurality of sectors are stored in a memory block. Accordingly, if the cache device 120 is applied to the flash memory, whenever a sector is flushed, a whole memory block including the sector has to be erased and rewritten.

### SUMMARY

In one general aspect, there is provided a cache management method comprising receiving a write request, from a host device, to write predetermined data to a predetermined sector of a storage device, determining whether a cache memory is allocated to a sector set including the predetermined sector of the storage device, selectively allocating the cache memory to the sector set based on a result of the determining, and storing the predetermined data into the cache memory allocated to the sector set.

The storage device may be a flash memory.

The cache management method may further comprise updating the sector set stored in the flash memory based on the data stored in the cache memory.

The updating may comprise reading data stored in other sectors of the sector set except for the predetermined sector, from the flash memory, generating data to be stored in the sector set based on the data stored in the other sectors and the predetermined data requested to be written, and writing the generated data into the flash memory.

The sector set may be determined based on erasing units of the flash memory.

The number of the erasing units may be a positive number multiplied by the block size of the flash memory.

In another aspect, there is provided a cache management method comprising receiving a read request, from a host device, to read predetermined data stored in a predetermined sector of a storage device, determining whether a cache memory is allocated to a sector set including the predetermined sector, selectively allocating the cache memory to the sector set based on a result of the determining, reading the predetermined data requested to be read from the storage device, and storing the read predetermined data in the cache memory allocated to the sector set, and transmitting the predetermined data to the host device.

The storage device may be a flash memory.

The storing of the read predetermined data into the cache memory may comprise, if the cache memory is not allocated to the sector set, allocating the cache memory to the sector set, reading the predetermined data requested to be read from the flash memory, and storing the read predetermined data in the cache memory allocated to the sector set.

The storing of the read predetermined data into the cache memory may comprise, if the cache memory is already allocated to the sector set, determining whether the predetermined data requested to be read exists in the cache memory allocated to the sector set, selectively reading the predetermined data from the flash memory based on whether the data requested to be read exists in the cache memory allocated to the sector set, and storing the read data in the cache memory allocated to the sector set.

The sector set may be determined based on erasing units of the flash memory.

The number of erasing units may be a positive number multiplied by the block size of the flash memory.

In another aspect, there is provided a cache device comprising a host interface for receiving a write request, from a host device, to write predetermined data to a predetermined sector of a storage device, a control unit for determining whether a cache memory is allocated to a sector set including the predetermined sector, and for selectively allocating the cache memory to the sector set based on a result of the determining, and a cache memory for storing the predetermined data based on a result of the allocating.

The storage device may be a flash memory.

The cache device may further comprise an update unit for updating the sector set stored in the flash memory based on the data stored in the cache memory.

The sector set may be determined based on erasing units of the flash memory.

In another aspect, there is provided a cache device comprising a host interface for receiving a read request, from a host device, to read predetermined data stored in a predetermined sector of a storage device, a control unit for determining whether a cache memory is allocated to a sector set including the predetermined sector, and for selectively allocating the cache memory to the sector set based on a result of the determining, and a cache memory for reading the predetermined data requested to be read from the storage device based on a result of the allocating and storing the read data, wherein the host interface transmits the predetermined data which is requested to be read, to the host device.

The storage device may be a flash memory.

The sector set may be determined based on erasing units of the flash memory.

In another aspect, there is provided a system comprising a host device for transmitting at least one of a write request to write predetermined data to a predetermined sector of a flash memory and a read request to read the predetermined data from the predetermined sector of the flash memory, a cache device for caching the predetermined data by managing a cache memory in sector sets including the predetermined sector, based on at least one of the write request and the read request, and a flash memory for receiving data in sector sets from the cache device and for performing at least one of writing the data and reading the data.

The sector set may be determined based on erasing units of the flash memory.

Other features and aspects may be apparent from the following description, the drawings, and the claims.

### BRIEF DESCRIPTION OF THE DRAWINGS

FIG. 1 is a diagram illustrating a conventional example of a cache management method.

FIG. 2 is a diagram illustrating a system including an example cache device.

FIG. 3 is a diagram illustrating an example of a cache management process.

FIG. 4 is a diagram illustrating an example of a process for updating a sector set.

FIG. 5 is a flowchart illustrating an example of a cache management method including a write request.

FIG. 6 is a flowchart illustrating an example of a cache management method including a read request.

Throughout the drawings and the description, unless otherwise described, the same drawing reference numerals are understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

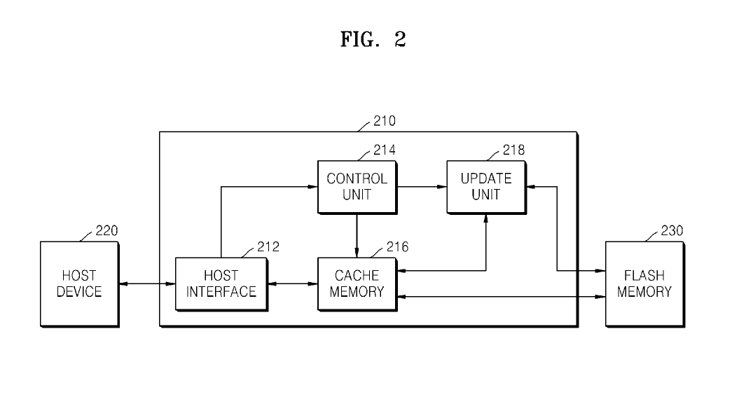

FIG. 2 illustrates a system including an example cache device.

Referring to FIG. 2, the cache device 210 includes a host interface 212, a control unit 214, a cache memory 216, and an update unit 218. In this example, a flash memory 230 is described as the storage device. However, this is merely for purposes of example, and it should be understood that the storage device may include any device capable of performing write and erase operations in different units.

The host device 220 transmits a write or read request for the flash memory 230, to the cache device 210. Thus, the host device 220 requests the cache device 210 to write data into a predetermined sector of the flash memory 230 or read data from a predetermined sector of the flash memory 230.

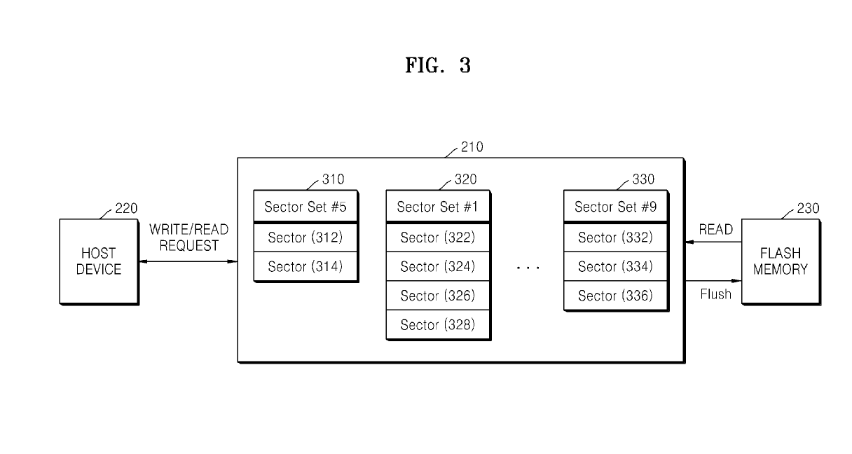

The cache device 210 manages the cache memory 216 in sector sets based on the write or read request of the host device 220. A sector set is a plurality of sectors including the sector that is requested to write or read data. The sector sets may be determined based on erasing units of the flash memory 230. In some embodiments, for example, the sector sets may be composed of a plurality of sequential sectors. The sector sets are described below with reference to FIG. 3.

The host interface 212 receives the write or read request transmitted by the host device 220. Upon receipt of the write or read request by the host interface 212, the control unit 214 determines whether the cache memory 216 is allocated to a sector set including the sector requested to write or read data.

FIG. 3 illustrates an example of a cache management process.

Referring to FIG. 2 and FIG. 3, the control unit 214 manages cache memory in sector sets 310, 320, and 330. As described above, the flash memory 230 does not enable overwriting. That is data may be written to memory blocks in which previously stored data has been erased. Accordingly, the control unit 214 manages the cache memory in sector sets which are determined based on erasing units of the flash memory 230.

For example, the flash memory 230 includes a memory element, the erasing unit of the flash memory 230 is a memory block, and the plurality of sectors allocated to the memory block are a sector set. However, if the flash memory 230 includes a plurality of memory elements, a plurality of memory blocks included in each memory element may be erased together. In this latter example, the number of erasing units is the number of memory blocks multiplied by the number of memory elements.

In the example shown in FIG. 3, sector sets 310, 320, and 330 are requested by the host device 220 to read or write data. When the sector sets are determined based on the erasing units of the flash memory 230, the control unit 214 allocates the cache memory to the sector sets 310, 320, and 330. That is, the host device 220 manages the cache memory in sector sets.

As illustrated in the example shown in FIG. 3, the cache memory is allocated to each of the sector sets 310, 320, and 330. Only the sectors requested by the host device 220 to write or read data are stored in the cache memory, and may be accessed by the host device 220.

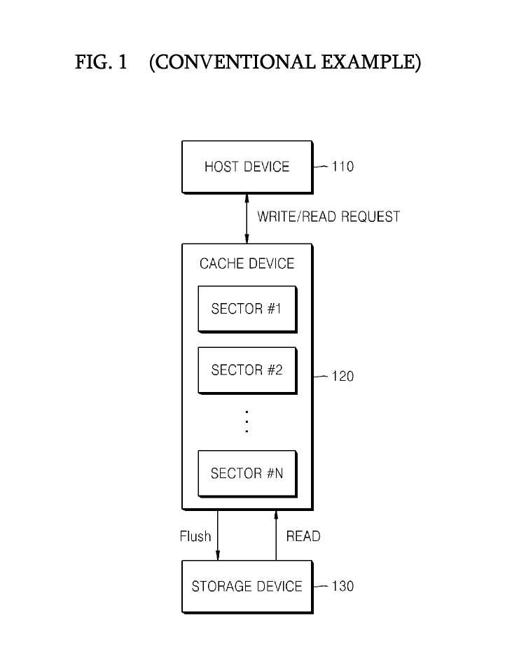

When data is flushed from the cache device 210 to the flash memory 230, the data is flushed not in sectors but in sector sets, thus, reducing the number of writing operations of the flash memory. If the flash memory 230 is applied to the cache device 120 according to the conventional example illustrated in FIG. 1, and flushes data in sectors, a whole memory block in which sectors are stored has to be erased and rewritten whenever a sector is flushed. However, in the cache device 210, the data is flushed in sector sets so that the number of flushing to the flash memory 230 may be reduced. That is, the entire memory block is not erased, but instead one or more sets of sectors may be erased. Accordingly, the number of writing and erasing operations for the writing of the flash memory 230 is reduced.

A least recently used (LRU) algorithm may also be used to determine the sector sets to be flushed. In the example shown in FIG. 3, Sector Set #5 310 may be the most recently used (MRU) sector set and Sector Set #9 330 may be the least recently used (LRU) sector set. In this example, when the cache memory has to be allocated to a new sector in accordance with a write or erase request of the host device 220, the control unit 214 may flush Sector Set #9 330 into the flash memory 230 and may allocate the cache memory to the new sector set.

For example, the MRU sector set may be determined based on whether an individual sector included in a sector set is the MRU sector out of all the sectors of all the sector sets. For example, if any of sectors 322, 324, 326, and 328, included in Sector Set #1 320, are the MRU sector, Sector Set #1 320 is the MRU sector set.

Referring back to FIG. 2, the control unit 214 may control the cache memory 316 using different methods based on whether the host device 220 transmits the write or read request. Examples of cache management methods of the control unit are described below based on a write example and a read operation example.

(1) Example Write Operation.

If the host interface 212 receives a write request of a predetermined sector from the host device 220, the control unit 214 determines whether the cache memory 216 is allocated to a sector set including the predetermined sector requested to write data.

If it is determined that the cache memory 216 is not allocated to the sector set, the control unit 214 controls the update unit 218 so as to flush the LRU sector set to the flash memory, allocates the cache memory 216 to the sector set that includes the predetermined sector requested to write data, and stores data requested to be written into the allocated cache memory 216. If it is determined that the cache memory 216 is allocated to the sector set, the data requested to be written is stored in the allocated cache memory 216.

(2) Example Read Operation.

If the host interface 212 receives a read request of a predetermined sector from the host device 220, the control unit 214 determines whether the cache memory 216 is allocated to a sector set including the predetermined sector requested to read data.

If it is determined that the cache memory 216 is not allocated to the sector set, the control unit 214 controls the update unit 218 so as to flush the LRU sector set to the flash memory and allocates the cache memory 216 to the sector set including the predetermined sector requested to read data. Then, data requested to be read is read from the flash memory and the read data is stored in the allocated cache memory 216.

If it is determined that the cache memory 216 is allocated to the sector set, the control unit 214 determines whether the data requested to be read exists in the allocated cache memory 216. The cache memory 216 only stores data of sectors previously accessed by the host device 220 from among sectors included in the sector set. Accordingly, although the cache memory 216 is allocated to the sector set, the data requested to be read may not exist in the cache memory 216. In this example, the control unit 214 may read the data requested to be read from the flash memory 230 and store the read data into the cache memory 216 allocated to the sector set.

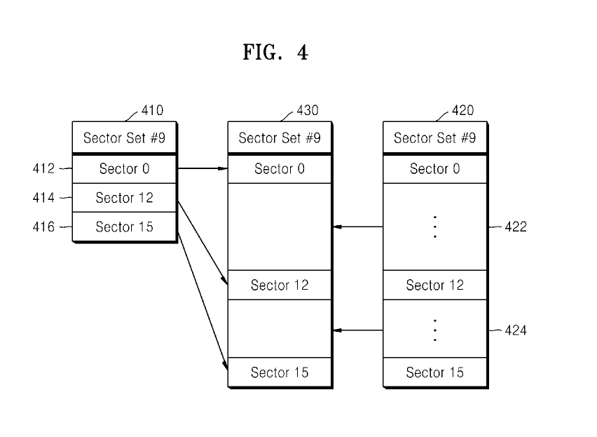

The update unit 218 flushes the sector set stored in the cache memory 216 into the flash memory 230 in accordance with the control of the control unit 214. In this example, the LRU sector set is flushed into the flash memory 230 in order to allocate the cache memory 216 to a new sector set. The flushing is performed by updating the sector set stored in the flash memory 230 based on the data stored in the cache memory 216. The flushing is described below with reference to FIG. 4.

FIG. 4 illustrates an example of updating a sector set. In the example shown in FIG. 4, it is assumed that Sector Set #9 410 is flushed into the flash memory 230.

Referring to FIG. 2 and FIG. 4, a sector set may include one or more sectors, for example, two sectors, three sectors, four sectors, or more. In this example, Sector Set #9 410 is composed of sixteen sectors including Sectors 0 through 15. However, in this example, only Sectors 0, 12, and 15 have been previously accessed by the host device 220 and have been stored in the cache memory 216. As described above, according to the characteristic of the flash memory 216, sector sets are determined based on erasing units and a whole memory block, that is, an erasing unit, has to be erased and rewritten. Thus, in order to flush Sector Set #9 410, data of the whole sector set has to be written.

Accordingly, the update unit 218 generates Sector Set #9 430 from the flash memory 230 in order to read and write data of each of the sectors of Sector Set #9. Sector Set #9 420 is the complete sector set stored in the cache memory 216. The update unit 218 retrieves Sectors 1-11, 13, and 14 from the Sector Set #9 420 stored in the flash memory 230, and combines Sectors 1-11, 13, and 14 with data of Sectors 0, 12, and 15 that are already stored in the cache memory 216 so as to generate Sector Set #9 430 that is to be written into the flash memory 230. The flushing is performed by writing the data of the Sector Set #9 430 into the flash memory 230. The Sector Set #9 420 that is stored in the flash memory 230 is erased before the data of the Sector Set #9 430 is written.

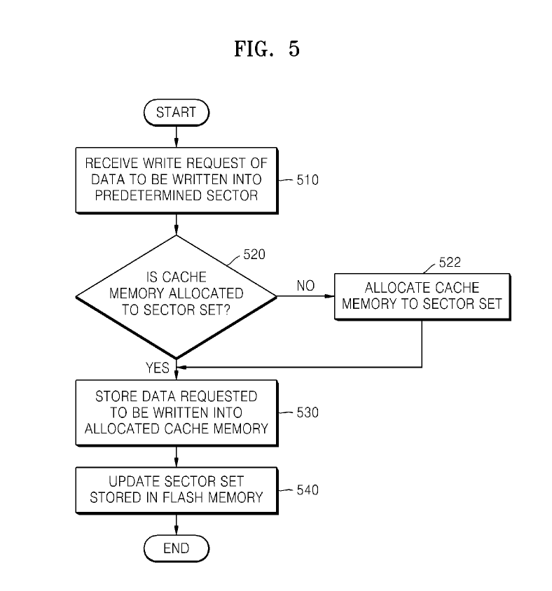

FIG. 5 illustrates a flowchart of an example cache management method including a write request.

Referring to FIG. 5, in 510, a cache device receives, from a host device, a write request for predetermined data to be written into a predetermined sector of a storage device. The host device accesses a flash memory.

In 520, the cache device determines whether a cache memory is allocated to a sector set including the sector. The cache management method manages the cache memory in sector sets determined based, not on sector units, but on erasing units of the flash memory. A determination is made as to whether the cache memory is allocated to the sector set, instead of to the sector.

If it is determined that the cache memory is not allocated to the sector set, in 522, the cache device flushes the LRU sector set stored in the cache memory into the flash memory and newly allocates the cache memory to the sector set including the sector.

If it is determined that the cache memory is already allocated to the sector set in 522 or if the cache memory is newly allocated to the sector set, in 530, the cache device writes/stores data requested to be written into the allocated cache memory.

In 540, the cache device updates the sector set stored in the flash memory based on the data stored in 530. In 530, the sector set in which the data is stored is flushed from the cache memory into the flash memory.

As described above with reference to FIG. 4, data of sectors of the sector set which are not stored in the cache memory are retrieved, and retrieved data and the data stored in the cache memory are combined. By the combining, data of a new sector set to be written into the flash memory is generated and the new sector set may be written to the flash memory. Data of a previous sector set stored in the flash memory is erased before the data of the new sector set is written into the flash memory.

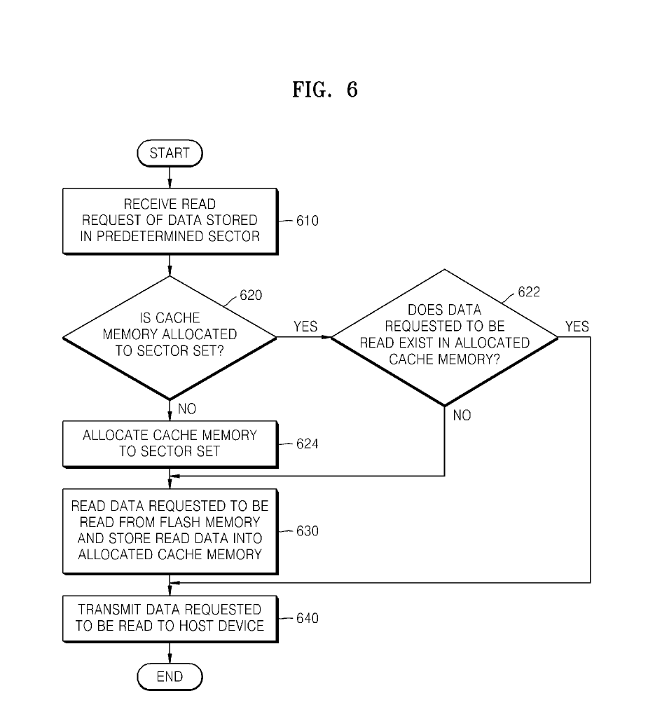

FIG. 6 illustrates a flowchart of an example cache management method including a read request.

Referring to FIG. 6, in 610, a cache device receives, from a host device, a read request of predetermined data stored in a predetermined sector of a storage device.

In 620, the cache device determines whether a cache memory is allocated to a sector set including the predetermined sector of the read request in 610.

If it is determined that the cache memory is not allocated to the sector set, in 624, the cache device allocates the cache memory to the sector set.

In 630, the cache device reads data requested to be read from a flash memory and stores the read data into the cache memory. Although the cache memory is already allocated to the sector set, if the data requested to be read does not exist in the cache memory in 622, or if the cache memory is not allocated to the sector set and the cache memory is newly allocated to the sector set in 624, the data requested to be read is read from the flash memory and the read data is stored in the cache memory allocated to the sector set.

In 640, the cache device transmits the data requested to be read to the host device. If the data is read from the flash memory and is stored in the cache memory in 640, or if it is determined that the data is already stored in the cache memory, the data requested to read data is transmitted to the host device.

The cache management method and the cache device described herein may be managed in sector sets. Instead of managing the cache in units of individual sectors, the cache is managed in units of sector sets. Thus, the number of writing and erasing operations may be reduced in the flash memory. Furthermore, by reducing the number of writing and erasing operations necessary for the writing, access speed of flash memory may be improved and the durability of the flash memory may be lengthened.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A cache management method comprising:
receiving a write request, from a host device, to write predetermined data to a predetermined sector of a storage device;
determining whether a cache memory is allocated to a sector set including the predetermined sector of the storage device;
selectively allocating the cache memory to the sector set based on a result of the determining; and
storing the predetermined data into the cache memory allocated to the sector set.

2. The cache management method of claim 1, wherein the storage device is a flash memory.

3. The cache management method of claim 2, further comprising updating the sector set stored in the flash memory based on the data stored in the cache memory.

4. The cache management method of claim 3, wherein the updating comprises:
reading data stored in other sectors of the sector set except for the predetermined sector, from the flash memory;
generating data to be stored in the sector set based on the data stored in the other sectors and the predetermined data requested to be written; and
writing the generated data into the flash memory.

5. The cache management method of claim 2, wherein the sector set is determined based on erasing units of the flash memory.

6. The cache management method of claim 5, wherein the number of the erasing units is a positive number multiplied by the block size of the flash memory.

7. A cache management method comprising:
receiving a read request, from a host device, to read predetermined data stored in a predetermined sector of a storage device;
determining whether a cache memory is allocated to a sector set including the predetermined sector;
selectively allocating the cache memory to the sector set based on a result of the determining, reading the predetermined data requested to be read from the storage device, and storing the read predetermined data in the cache memory allocated to the sector set; and
transmitting the predetermined data to the host device.

8. The cache management method of claim 7, wherein the storage device is a flash memory.

9. The cache management method of claim 8, wherein the storing of the read predetermined data into the cache memory comprises:
if the cache memory is not allocated to the sector set, allocating the cache memory to the sector set;
reading the predetermined data requested to be read from the flash memory; and
storing the read predetermined data in the cache memory allocated to the sector set.

10. The cache management method of claim 8, wherein the storing of the read predetermined data into the cache memory comprises:
if the cache memory is already allocated to the sector set, determining whether the predetermined data requested to be read exists in the cache memory allocated to the sector set;
selectively reading the predetermined data from the flash memory based on whether the data requested to be read exists in the cache memory allocated to the sector set; and
storing the read data in the cache memory allocated to the sector set.

11. The cache management method of claim 8, wherein the sector set is determined based on erasing units of the flash memory.

12. The cache management method of claim 11, wherein the number of erasing units is a positive number multiplied by the block size of the flash memory.

13. A cache device comprising:
a host interface for receiving a write request, from a host device, to write predetermined data to a predetermined sector of a storage device;
a control unit for determining whether a cache memory is allocated to a sector set including the predetermined sector, and for selectively allocating the cache memory to the sector set based on a result of the determining; and
a cache memory for storing the predetermined data based on a result of the allocating.

14. The cache device of claim 13, wherein the storage device is a flash memory.

15. The cache device of claim 14, further comprising an update unit for updating the sector set stored in the flash memory based on the data stored in the cache memory.

16. The cache device of claim 14, wherein the sector set is determined based on erasing units of the flash memory.

17. A cache device comprising:
a host interface for receiving a read request, from a host device, to read predetermined data stored in a predetermined sector of a storage device;
a control unit for determining whether a cache memory is allocated to a sector set including the predetermined sector, and for selectively allocating the cache memory to the sector set based on a result of the determining; and
a cache memory for reading the predetermined data requested to be read from the storage device based on a result of the allocating and storing the read data,
wherein the host interface transmits the predetermined data which is requested to be read, to the host device.

18. The cache device of claim 17, wherein the storage device is a flash memory.

19. The cache device of claim 18, wherein the sector set is determined based on erasing units of the flash memory.

20. A system comprising:
a host device for transmitting at least one of a write request to write predetermined data to a predetermined sector of a flash memory and a read request to read the predetermined data from the predetermined sector of the flash memory;
a cache device for caching the predetermined data by managing a cache memory in sector sets including the predetermined sector, based on at least one of the write request and the read request; and
a flash memory for receiving data in sector sets from the cache device and for performing at least one of writing the data and reading the data.

21. The system of claim 20, wherein the sector set is determined based on erasing units of the flash memory.
